(19) United States
(12) Patent Application Publication
(10) Pub. No.: US 2023/0139686 A1
(43) Pub. Date: May 4, 2023

(54) TIRE REVOLUTION DIRECTION DETERMINATION SYSTEM

(71) Applicant: KABUSHIKI KAISHA TOKAI RIKA DENKI SEISAKUSHO, Aichi (JP)

(72) Inventor: Masanori KOSUGI, Aichi (JP)

(73) Assignee: KABUSHIKI KAISHA TOKAI RIKA DENKI SEISAKUSHO, Aichi (JP)

(21) Appl. No.: 17/972,817

(22) Filed: Oct. 25, 2022

(30) Foreign Application Priority Data
Oct. 29, 2021 (JP) 2021-177599

(51) Int. Cl. G01P 15/16; B60C 23/04

(52) U.S. Cl. CPC G01P 15/165; B60C 23/0488

(57) ABSTRACT

A tire revolution direction determination system includes a detection device arranged in each of two tires coupled back-to-back and a monitoring unit. The detection device includes a first detector that detects a first acceleration in a tire diameter direction and a second detector that detects a second acceleration in the tire diameter direction. The first detector is arranged in front of the second detector in a reference direction. When the monitoring unit receives the first acceleration and the second acceleration from the detection device while a vehicle travels forward, it specifies change over time of the first acceleration and change over time of the second acceleration and determines whether a direction of revolution of the tire where the detection device is arranged is the reference direction based on whether change over time of the first acceleration is more advanced than change over time of the second acceleration.

This nonprovisional application is based on Japanese Patent Application No. 2021-177599 filed with the Japan Patent Office on Oct. 29, 2021, the entire contents of which are hereby incorporated by reference.

### BACKGROUND OF THE INVENTION

### Field of the Invention

The present disclosure relates to a system that determines a direction of revolution of a tire attached to a vehicle.

### Description of the Background Art

A direct tire pressure monitoring system (TPMS) has conventionally been available as one of tire pressure monitoring systems. In the TPMS of this type, a detection device provided with a sensor such as a pressure sensor is directly attached to a vehicle wheel side where a tire is attached. On a vehicle body side, an antenna and a receiver are provided. When a detection signal from the sensor is transmitted from the detection device on the vehicle wheel side, the receiver receives the detection signal through the antenna and a tire pressure is detected.

For such a direct TPMS, various apparatuses with a function to determine in which tire of a vehicle a detection device attached to the tire is provided have been developed. For example, Japanese Patent Laying-Open No. 2019-48547 discloses a system that determines to which tire of double tires employed in a truck and the like a detection device is attached. This system includes a sensor that detects an acceleration in a tire revolution circumferential direction, determines a direction of revolution of the tire based on a result of detection of the acceleration in the tire revolution circumferential direction, and determines in which of the double tires a detector is provided based on a result of determination of the direction of revolution of the tire.

### SUMMARY OF THE INVENTION

The system disclosed in Japanese Patent Laying-Open No. 2019-48547 determines the direction of revolution of the tire where the detector is arranged based on the result of detection of the acceleration in the tire revolution circumferential direction. The acceleration in the tire revolution circumferential direction, however, cannot be detected unless the vehicle is accelerating. In other words, the system disclosed in Japanese Patent Laying-Open No. 2019-48547 is unable to determine the direction of revolution of the tire unless the vehicle is accelerating.

The present disclosure was made to solve the problem described above, and an object thereof is to enable determination of a direction of revolution of a tire even when a vehicle is in a constant-velocity traveling state in which the vehicle is traveling at a constant velocity.

A tire revolution direction determination system according to one aspect of the present disclosure is a tire revolution direction determination system that determines a direction of revolution of a tire attached to a vehicle, and the tire revolution direction determination system includes a detection device arranged in the tire and a determination device configured to obtain information from the detection device. The detection device includes a first sensor arranged in the tire, the first sensor detecting a first acceleration in a tire diameter direction, and a second sensor arranged in the tire, the second sensor detecting a second acceleration in the tire diameter direction. The tire includes a wheel portion including a first-side surface and a second-side surface on a rear side of the first-side surface. With a direction of clockwise revolution when the tire is viewed from the second-side surface being defined as a reference direction, the first sensor is arranged in front of the second sensor in the reference direction. When the determination device receives the first acceleration and the second acceleration from the detection device while the vehicle travels forward, the determination device specifies change over time of the first acceleration and change over time of the second acceleration, and determines whether the direction of revolution of the tire where the detection device is arranged is the reference direction based on whether change over time of the first acceleration is more advanced than change over time of the second acceleration.

According to the aspect above, whether or not the direction of revolution of the tire is the reference direction is determined based not on the acceleration in a tire revolution circumferential direction but on the acceleration (the first acceleration and the second acceleration) in the tire diameter direction. Therefore, even when the vehicle is in the constant-velocity traveling state, the direction of revolution of the tire can be determined.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically showing a configuration of a vehicle.

FIG. 2 is a block diagram showing a configuration of a detection device.

FIG. 3 is a diagram for illustrating a direction of detection of an acceleration by a first detector and a second detector.

FIG. 4 is a diagram schematically showing a waveform of a component of an acceleration of gravity superimposed on a first acceleration G1 and a second acceleration G2 when a vehicle is traveling forward at a constant vehicle velocity.

FIG. 5 is an exploded perspective view of double tires on a rear right side.

FIG. 6 is a flowchart showing an exemplary procedure of processing by a monitoring unit.

### DESCRIPTION OF THE PREFERRED EMBODIMENTS

An embodiment of the present disclosure will be described in detail below with reference to the drawings. The same or corresponding elements in the drawings have the same reference characters allotted and description thereof will not be repeated.

<Overall Configuration>

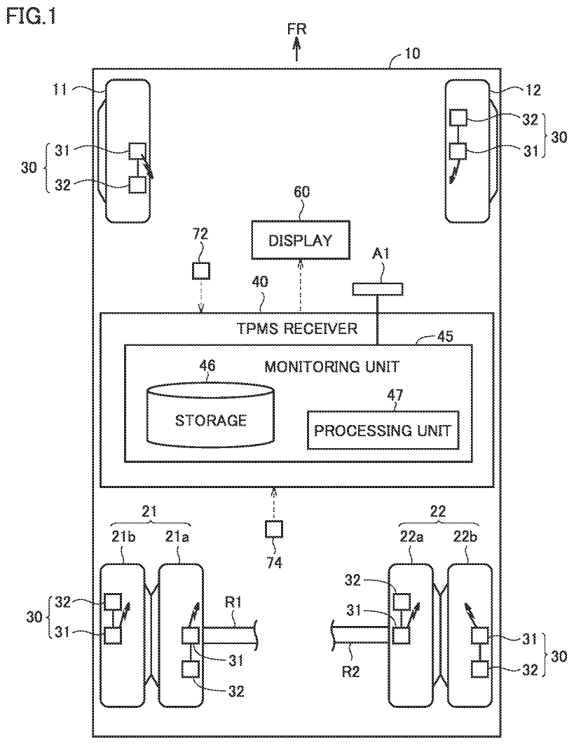

FIG. 1 is a diagram schematically showing a configuration of a vehicle 10 to which a tire revolution direction determination system according to the present embodiment is applied.

Vehicle 10 according to the present embodiment is a vehicle including a single tire as a front wheel which is a steering wheel and double (twin or dual) tires as a rear wheel which is a non-steering wheel. The single tire refers to a form of attachment of a single tire at one tire attachment position. The double tires refer to a form of attachment of two tires of the same size coupled to each other at one tire attachment position. The double tires are mainly adopted in a large-sized vehicle such as a truck or a bus.

Specifically, vehicle 10 includes front tires 11 and 12 and rear double tires 21 and 22.

FIG. 1 illustrates an example in which vehicle 10 is a rear-wheel drive type. Rear double tires 21 and 22 are attached to an axle R1 on a rear left side and an axle R2 on a rear right side, respectively. Vehicle 10 is not limited to the rear-wheel drive type but may be a front-wheel drive type or an all-wheel drive type.

Double tires 21 on the rear left side include a tire 21a on a vehicle inner side and a tire 21b on a vehicle outer side. Double tires 22 on the rear right side include a tire 22a on the vehicle inner side and a tire 22b on the vehicle outer side.

Vehicle 10 further includes a system that monitors a pneumatic pressure of each tire (TPMS). Specifically, vehicle 10 includes a detection device 30 arranged in each of six tires 11, 12, 21a, 21b, 22a, and 22b and a TPMS receiver 40. For example, detection device 30 may be formed integrally with a valve for intake of air into each tire.

Detection device 30 is activated when a prescribed activation condition is satisfied, and detects a tire pressure and outputs a radio signal in an ultra high frequency (UHF) band (which is also simply referred to as a “UHF signal” below) that includes a result of detection. The “prescribed activation condition” is set in advance for each detection device 30 to be satisfied regularly or irregularly. Detection devices 30 can thus intermittently be activated at timings different from one another.

The UHF signal outputted from each detection device 30 includes not only information indicating a tire pressure but also information indicating a specific ID number for identifying at least each detection device 30. As TPMS receiver 40 receives the UHF signal outputted from each detection device 30, it can monitor a pneumatic pressure of each tire.

Tires identical in specifications and construction are employed as tires 11, 12, 21a, 21b, 22a, and 22b for allowing tire rotation. Therefore, detection devices identical in configuration are adopted also for detection devices 30.

Each detection device 30 includes a first detector 31 and a second detector 32. A configuration of detection device 30 will be described in detail later.

TPMS receiver 40 is provided on a vehicle body side of vehicle 10. TPMS receiver 40 includes an antenna A1 and a monitoring unit 45. Antenna A1 is configured to receive a UHF signal transmitted from each detection device 30. Monitoring unit 45 monitors a pneumatic pressure of each tire based on the UHF signal received by antenna A1. Monitoring unit 45 includes a storage 46 and a processing unit 47.

Processing unit 47 includes a processor such as a not-shown central processing unit (CPU), a memory, and an input and output buffer. The memory includes a read only memory (ROM) and a random access memory (RAM). The processor develops a program stored in the ROM on the RAM and executes the same. Various types of processing performed by processing unit 47 are described in the program stored in the ROM.

Information indicating a position of a tire where each detection device 30 is arranged and information indicating a tire pressure are stored in storage 46 as being brought in correspondence with an ID number of each detection device 30. In the present embodiment, six tire positions (a front left side, a front right side, a rear left inner side, a rear left outer side, a rear right inner side, and a rear right outer side) in total are set in advance and an ID number of each detection device 30 is brought in correspondence with any one tire position.

When monitoring unit 45 receives a UHF signal from each detection device 30, it specifies the tire position based on the ID number included in the UHF signal by referring to the information stored in storage 46 and updates the pneumatic pressure at the specified tire position with the tire pressure included in the UHF signal.

TPMS receiver 40 can have information on correspondence between the tire position and the tire pressure stored in storage 46 shown on a display 60. Display 60 is arranged at a position where a driver can visually recognize the same. Display 60 is arranged, for example, in an instrument panel within the vehicle.

When the tire pressure included in the received UHF signal is equal to or lower than a low-pressure threshold value, monitoring unit 45 has the tire position where the tire pressure is equal to or lower than the low-pressure threshold value shown on display 60 together with a warning. TPMS receiver 40 performs processing for determining the tire pressure for each received UHF signal and monitors each pneumatic pressure of each tire. The driver can thus recognize in real time the position of the tire the tire pressure of which has become equal to or lower than the low-pressure threshold value.

<Configuration of Detection Device 30>

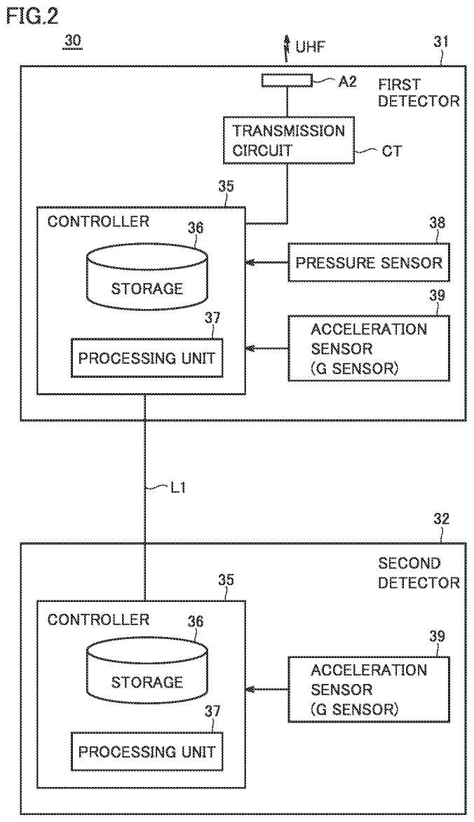

FIG. 2 is a block diagram showing a configuration of detection device 30. Detection device 30 includes first detector 31 and second detector 32 as described above. First detector 31 and second detector 32 are electrically connected to each other through a connection line L1.

First detector 31 includes a controller 35, a pressure sensor 38, an acceleration sensor (G sensor) 39, an antenna A2, and a transmission circuit CT.

Pressure sensor 38 detects a tire pressure and outputs a result of detection to controller 35. Acceleration sensor 39 is a uniaxial acceleration sensor that detects an acceleration in one direction. Acceleration sensor 39 detects an acceleration applied to first detector 31 and outputs a result of detection (which is also referred to as a “first acceleration G1” below) to controller 35.

Detection device 30 may further include a temperature sensor that detects a tire temperature in addition to pressure sensor 38 and acceleration sensor 39

Controller 35 of first detector 31 includes a storage 36 and a processing unit 37. Processing unit 37 includes a processor such as a not-shown CPU, a memory, and an input and output buffer. The memory includes a ROM and a RAM. The processor develops a program stored in the ROM on the RAM and executes the same. Various types of processing performed by processing unit 37 are described in the program stored in the ROM.

Information indicating an ID number specific for each detection device 30, a result of detection by pressure sensor 38, and a result of detection (first acceleration G1) by acceleration sensor 39 of first detector 31 is stored in storage 36 of first detector 31.

Second detector 32 includes controller 35 and acceleration sensor (G sensor) 39. Second detector 32 is a detector without antenna A2, transmission circuit CT, and pressure sensor 38 provided in first detector 31.

Similarly to acceleration sensor 39 of first detector 31, acceleration sensor 39 of second detector 32 is also a uniaxial acceleration sensor that detects an acceleration in one direction. Acceleration sensor 39 of second detector 32 detects an acceleration applied to second detector 32 and outputs a result of detection (which is also referred to as a “second acceleration G2” below) to controller 35 of second detector 32.

Controller 35 of second detector 32 includes storage 36 and processing unit 37 similar to those of controller 35 of first detector 31. Information indicating a result of detection (second acceleration G2) by acceleration sensor 39 of second detector 32 is stored in storage 36 of second detector 32.

Controller 35 of second detector 32 is configured to output information on second acceleration G2 stored in storage 36 of second detector 32 to first detector 31.

Controller 35 of first detector 31 controls transmission circuit CT to output a UHF signal from antenna A2. The UHF signal includes an ID number stored in storage 36, information indicating a tire pressure, information indicating first acceleration G1, and information indicating second acceleration G2.

<Direction of Detection of Acceleration by First Detector 31 and Second Detector 32>

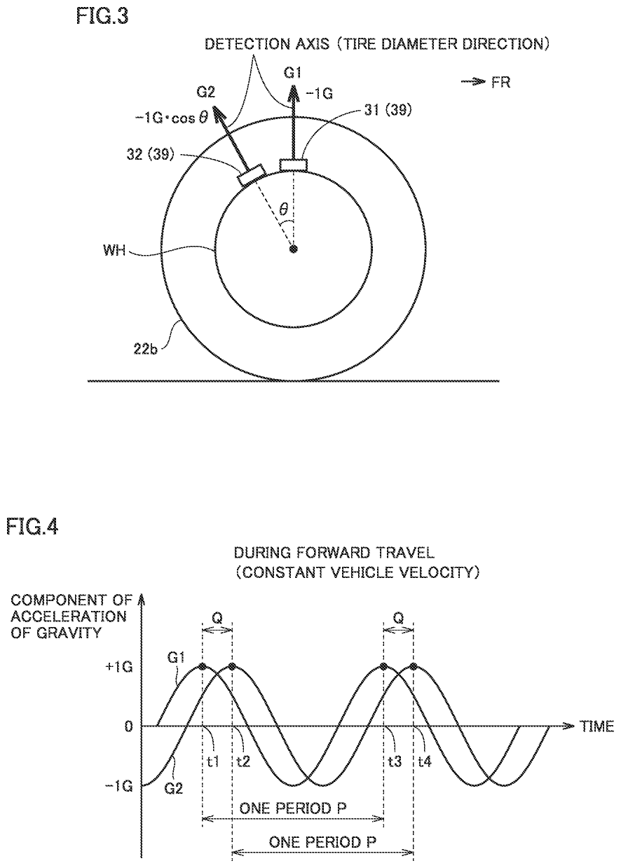

FIG. 3 is a diagram for illustrating a direction of detection of an acceleration by first detector 31 and second detector 32. FIG. 3 illustratively shows arrangement of first detector 31 and second detector 32 when tire 22b on the rear right outer side is seen through from the vehicle outer side. Arrangement of first detector 31 and second detector 32 is the same also in tires other than tire 22b.

First detector 31 and second detector 32 are fixed to an outer circumferential surface of a wheel WH of each tire. First detector 31 and second detector 32 are arranged at positions distant by a prescribed angle of revolution θ from each other.

Each of first detector 31 and second detector 32 detects an acceleration (a centrifugal acceleration) in a tire diameter direction. Acceleration sensor 39 of first detector 31 and acceleration sensor 39 of second detector 32 are configured to detect an acceleration applied in a direction away from a revolution center of the tire as a positive value and to detect an acceleration applied in a direction toward the revolution center of the tire as a negative value. In this case, each of accelerations G1 and G2 detected by acceleration sensors 39 has a value resulting from superimposition of a component of an acceleration of gravity that varies with an angle of revolution of the tire on a centrifugal acceleration of the tire.

For example, when first detector 31 is located at a position at “twelve o'clock” as shown in FIG. 3, the component of the acceleration of gravity superimposed on first acceleration G1 detected by first detector 31 is “−1 G” (G: acceleration of gravity) and the component of the acceleration of gravity superimposed on second acceleration G2 detected by second detector 32 is “−1 G● cos θ”.

Though FIG. 3 shows an example in which first detector 31 and second detector 32 are arranged on the outer circumferential surface of wheel WH of each tire, first detector 31 and second detector 32 should only be arranged at positions where the acceleration (centrifugal acceleration) in the tire diameter direction can be detected, and the positions of arrangement of first detector 31 and second detector 32 are not necessarily limited to positions on the outer circumferential surface of wheel WH. For example, first detector 31 and second detector 32 may be arranged on an inner wall of a rubber portion of each tire or an outer surface of the rubber portion of each tire.

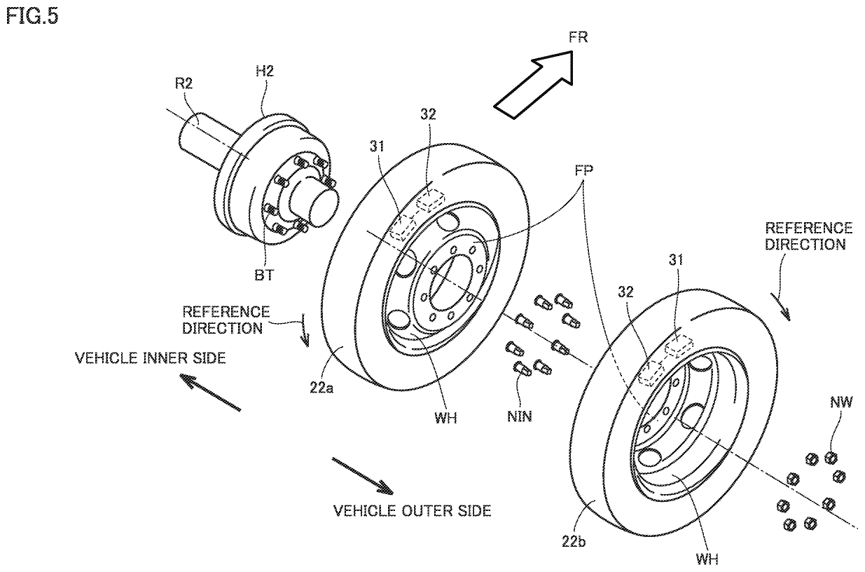

FIG. 4 is a diagram schematically showing a waveform of a component of an acceleration of gravity superimposed on first acceleration G1 and second acceleration G2 when vehicle 10 is traveling forward at a constant vehicle velocity. As shown in FIG. 4, while vehicle 10 is traveling forward at a constant vehicle velocity, that is, while the tire is revolving in a forward revolution direction at the constant velocity, the component of the acceleration of gravity superimposed on first acceleration G1 and second acceleration G2 has a sinusoidal waveform with a time period for one revolution of the tire being defined as one period P.

Change over time of the component of the acceleration of gravity superimposed on first acceleration G1 and change over time of the component of the acceleration of gravity superimposed on second acceleration G2 deviate from each other by a time difference Q corresponding to a prescribed angle of revolution θ.

Though a waveform outputted from each acceleration sensor 39 has a value calculated by adding the centrifugal acceleration to the component of the acceleration of gravity, the centrifugal acceleration does not periodically vary in one revolution of the tire. Therefore, change over time of the component of the acceleration of gravity superimposed on first acceleration G1 is also simply referred to as “change over time of first acceleration G1” below and change over time of the component of the acceleration of gravity superimposed on second acceleration G2 is also simply referred to as “change over time of second acceleration G2” below.

Prescribed angle of revolution θ should only be smaller than 180° and more preferably smaller than 90°. In the present embodiment, prescribed angle of revolution θ is set to approximately 30°. By thus setting angle of revolution θ, monitoring unit 45 or controller 35 can know relation (retardation and advance) between change over time of first acceleration G1 and change over time of second acceleration G2 as will be described later.

<Construction of Double Tires>

Vehicle 10 according to the present embodiment includes double tires 21 and 22 as the rear wheels which are non-steering wheels as described above.

FIG. 5 is an exploded perspective view of double tires 22 on the rear right side. An exemplary construction of double tire 22 will be described with reference to FIG. 5. Double tires 21 on the rear left side are also similar in construction to double tires 22.

Double tires 22 include tire 22a on the vehicle inner side (which is also referred to as an “inner tire 22a” below) and tire 22b on the vehicle outer side (which is also referred to as an “outer tire 22b” below). Wheel WH of each of tires 22a and 22b includes a flat portion FP that protrudes on the outer side relative to a side surface portion (a sidewall portion) of each tire. Wheel WH includes a first-side surface on a side where flat portion FP protrudes and a second-side surface on a rear side of the first-side surface.

Inner tire 22a is fixed to axle R2 by being fastened by an inner nut NIN by insertion of a bolt BT of a hub H2 of axle R2 into a hole provided in flat portion FP of wheel WH. A tip end side (vehicle outer side) of inner nut NIN is threaded.

Outer tire 22b is fixed to inner tire 22a by being fastened by a wheel nut NW by insertion of the thread on the tip end side of inner nut NIN into the hole provided in flat portion FP of wheel WH. Inner tire 22a and outer tire 22b are fixed while flat portions FP of wheels WH face each other. Inner tire 22a and outer tire 22b are thus connected to axle R2 as being coupled back-to-back.

Therefore, with a clockwise direction when each wheel WH is viewed from the side of the second-side surface being defined as the “reference direction,” when vehicle 10 travels forward, the direction of revolution of outer tire 22b is the same as the reference direction whereas the direction of revolution of inner tire 22a is the direction reverse to the reference direction.

As shown in FIG. 5, in each of inner tire 22a and outer tire 22b, first detector 31 is arranged in front of second detector 32 in the reference direction. Therefore, while vehicle 10 travels forward, in outer tire 22b that revolves in the reference direction, change over time of first acceleration G1 is more advanced than change over time of second acceleration G2, whereas in inner tire 22a that revolves in the direction reverse to the reference direction, change over time of first acceleration G1 is lagged behind change over time of second acceleration G2.

The “reference direction” described above may be set to the clockwise direction when each wheel WH is viewed from a side of the first-side surface, and in that case, relation between the reference direction and the direction of revolution of each of tires 22a and 22b is opposite.

So long as three conditions below are satisfied, a condition of arrangement of first detector 31 and second detector 32 is not necessarily limited to the condition of arrangement shown in FIGS. 3 and 5.

(Arrangement Condition 1)

When each wheel WH is viewed from the side of the first-side surface (the side where flat portion FP protrudes), a positive direction of the acceleration is defined in the same direction.

(Arrangement Condition 2)

When each wheel WH is viewed from the side of the first-side surface, the detectors are attached to the same surface.

(Arrangement Condition 3)

When each wheel WH is viewed from the side of the first-side surface, positional relation with respect to the reference direction is unified.

<Determination of Direction of Revolution and Determination as to Inner Side or Outer Side of Double Tires>

As described above, while vehicle 10 travels forward, in outer tire 22b, change over time of first acceleration G1 is more advanced than change over time of second acceleration G2, whereas in inner tire 22a, change over time of first acceleration G1 is lagged behind change over time of second acceleration G2.

In view of this fact, each detection device 30 according to the present embodiment is configured to output to monitoring unit 45, a result of detection of first acceleration G1 and second acceleration G2 at a plurality of (at least two) consecutive timings. Then, when monitoring unit 45 receives the result of detection from detection device 30, it performs processing for determining whether that detection device 30 is arranged in the inner tire or the outer tire of the double tires (which is also referred to as “determination as to the inner side or the outer side of the double tires” below) in a manner as below.

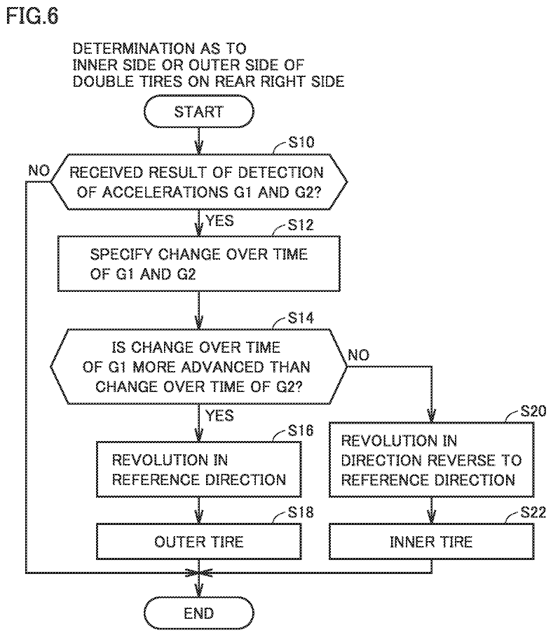

FIG. 6 is a flowchart showing an exemplary procedure of processing when monitoring unit 45 makes determination as to the inner side or the outer side of the double tires. This flowchart is performed while vehicle 10 travels. FIG. 6 shows an example of determination as to the inner side or the outer side of double tires 22 on the rear right side.

Monitoring unit 45 determines whether or not it has received the result of detection of first acceleration G1 and second acceleration G2 at a plurality of (at least two) consecutive timings from detection device 30 arranged in any one of double tires 22 on the rear right side (step S10).

When monitoring unit 45 makes determination as NO in step S10, it is unable to specify change over time of first acceleration G1 and change over time of second acceleration G2, and hence it skips subsequent steps and quits the process.

When monitoring unit 45 makes determination as YES in step S10, it can accurately specify change over time of first acceleration G1 and change over time of second acceleration G2, and hence it specifies change over time of each of accelerations G1 and G2 based on the result of detection received in step S10 (step S12).

Then, monitoring unit 45 determines whether or not change over time of acceleration G1 is more advanced than change over time of acceleration G2 (step S14). As described above, in the present embodiment, prescribed angle of revolution θ (a difference between an angle at which first detector 31 is arranged and an angle at which second detector 32 is arranged) is set to approximately 30° as shown in FIG. 3. Monitoring unit 45 can thus accurately determine whether or not change over time of acceleration G1 is more advanced than change over time of acceleration G2. In other words, for example, when angle of revolution θ is set to 180°, the difference between change over time of acceleration G1 and change over time of acceleration G2 is comparable to 180°, and retardation and advance of change over time cannot accurately be determined. In the present embodiment, however, since angle of revolution θ is set to approximately 30°, such a problem can be solved.

When change over time of acceleration G1 is more advanced than change over time of acceleration G2 (YES in step S14), monitoring unit 45 determines that detection device 30 that has outputted the result of detection received in step S10 revolves in the reference direction (step S16). Then, in view of the fact that it is outer tire 22b that revolves in the reference direction in forward travel of the vehicle in double tires 22 on the rear right side (see FIG. 5), monitoring unit 45 determines that detection device 30 that has outputted the result of detection received in step S10 is located in outer tire 22b (step S18).

When change over time of acceleration G1 is lagged behind change over time of acceleration G2 (NO in step S14), monitoring unit 45 determines that detection device 30 that has outputted the result of detection received in step S10 revolves in the direction reverse to the reference direction (step S20). Then, in view of the fact that it is inner tire 22a that revolves in the direction reverse to the reference direction in forward travel of the vehicle in double tires 22 on the rear right side (see FIG. 5), monitoring unit 45 determines that detection device 30 that has outputted the result of detection received in step S10 is located in inner tire 22a (step S22).

As set forth above, the tire revolution direction determination system according to the present disclosure includes detection device 30 arranged in each of tires and monitoring unit 45. Detection device 30 includes first detector 31 that detects first acceleration G1 in the tire diameter direction and second detector 32 that detects second acceleration G2 in the tire diameter direction. First detector 31 is arranged in front of second detector 32 in the reference direction. When monitoring unit 45 receives first acceleration G1 and second acceleration G2 from detection device 30 while vehicle 10 travels forward, it specifies change over time of first acceleration G1 and change over time of second acceleration G2 and determines whether or not the direction of revolution of the tire where detection device 30 is arranged is the reference direction based on whether or not change over time of first acceleration G1 is more advanced than change over time of second acceleration G2.

According to the aspect above, whether or not the direction of revolution of the tire is the reference direction is determined based not on the acceleration in the tire revolution circumferential direction but on the acceleration (first acceleration G1 and second acceleration G2) in the tire diameter direction. Therefore, even when vehicle 10 is in the constant-velocity traveling state, the direction of revolution of the tire can be determined.

[First Modification]

In the embodiment above, an example in which a tire position determination manner according to the present disclosure is applied to determination as to the inner side or the outer side of the double tires coupled back-to-back is described.

The tires to which the tire position determination manner according to the present disclosure is applicable, however, should only be two tires arranged back-to-back in the vehicle, and not necessarily limited to double tires. For example, the tire position determination manner according to the present disclosure may be applied to front tires 11 and 12 back-to-back arranged in vehicle 10 so as to determine in which of front tires 11 and 12 detection device 30 is arranged.

[Second Modification]

In the embodiment above, an example in which two acceleration sensors 39 are arranged as being aligned in the reference direction in each tire is described. The number of acceleration sensors 39 arranged as being aligned in the reference direction in each tire, however, is not limited to two, and three or more acceleration sensors 39 may be provided.

[Third Modification]

In the embodiment above, an example in which monitoring unit 45 provided on the vehicle body side of vehicle 10 determines relation between change over time of first acceleration G1 and change over time of second acceleration G2 based on first acceleration G1 and second acceleration G2 received from detection device 30 and determines the direction of revolution of the tire based on the result of determination is described.

The determination device that determines relation between change over time of first acceleration G1 and change over time of second acceleration G2 and determines the direction of revolution of the tires, however, is not necessarily provided on the vehicle body side, and may be arranged in each tire. For example, controller 35 of first detector 31 arranged in each tire may determine relation between change over time of first acceleration G1 and change over time of second acceleration G2 based on first acceleration G1 and second acceleration G2 obtained from acceleration sensor 39 of first detector 31 and acceleration sensor 39 of second detector 32, and determine the direction of revolution of the tires based on the result of determination.

It should be understood that the embodiment disclosed herein is illustrative and non-restrictive in every respect. The scope of the present disclosure is defined by the terms of the claims rather than the description above and is intended to include any modifications within the scope and meaning equivalent to the terms of the claims.

The illustrative embodiment and the modifications thereof described above are specific examples of aspects below.

(1) A tire revolution direction determination system according to the present disclosure is a tire revolution direction determination system that determines a direction of revolution of a tire attached to a vehicle, and the tire revolution direction determination system includes a detection device arranged in the tire and a determination device configured to obtain information from the detection device. The detection device includes a first sensor arranged in the tire, the first sensor detecting a first acceleration in a tire diameter direction, and a second sensor arranged in the tire, the second sensor detecting a second acceleration in the tire diameter direction. The tire includes a wheel portion including a first-side surface and a second-side surface on a rear side of the first-side surface. With a direction of clockwise revolution when the tire is viewed from the second-side surface being defined as a reference direction, the first sensor is arranged in front of the second sensor in the reference direction. When the determination device receives the first acceleration and the second acceleration from the detection device while the vehicle travels forward, the determination device specifies change over time of the first acceleration and change over time of the second acceleration, and determines whether the direction of revolution of the tire where the detection device is arranged is the reference direction based on whether change over time of the first acceleration is more advanced than change over time of the second acceleration.

According to the aspect above, whether or not the direction of revolution of the tire is the reference direction is determined based not on the acceleration in a tire revolution circumferential direction but on the acceleration (the first acceleration and the second acceleration) in the tire diameter direction. Therefore, even when the vehicle is in a constant-velocity traveling state, the direction of revolution of the tire can be determined.

(2) In one aspect, the first sensor is arranged at a position distant by a prescribed angle of revolution in the reference direction from the second sensor. The prescribed angle of revolution is set to a value smaller than 180°.

According to the aspect above, the determination device can determine whether or not change over time of the first acceleration is more advanced than change over time of the second acceleration more accurately than in an example where the prescribed angle of revolution is set, for example, to 180°.

(3) In one aspect, the detection device is configured to transmit to the determination device, a result of detection of the first acceleration and the second acceleration at a plurality of consecutive timings.

According to the aspect above, the determination device can accurately specify change over time of the first acceleration and the second acceleration.

(4) In one aspect, when change over time of the first acceleration received from the detection device is more advanced than change over time of the second acceleration, the determination device determines the direction of revolution of the tire where the detection device is arranged as the reference direction. When change over time of the first acceleration received from the detection device is lagged behind change over time of the second acceleration, the determination device determines the direction of revolution of the tire where the detection device is arranged as a direction reverse to the reference direction.

According to the aspect above, whether the direction of revolution of the tire where the detection device is arranged is the reference direction or the direction reverse to the reference direction can be determined based on relation (retardation and advance) between change over time of the first acceleration and change over time of the second acceleration.

(5) In one aspect, the determination device is arranged in the tire.

According to the aspect above, the determination device arranged in the tire can determine the direction of revolution of the tire.

(6) In one aspect, the detection device is arranged in each of two tires attached back-to-back to the vehicle. The determination device determines in which of the two tires the detection device is arranged based on a result of determination of the direction of revolution of the tire where the detection device is arranged.

According to the aspect above, in which of two tires attached back-to-back to the vehicle the detection device is arranged can be determined.

(7) In one aspect, the two tires are double tires coupled in such a manner that the first-side surfaces of the two tires face each other. While the double tires are attached on a right side of the vehicle, when the direction of revolution of the tire where the detection device is arranged is the reference direction, the determination device determines that the detection device is arranged in a tire on a vehicle outer side, of the double tires, and when the direction of revolution of the tire where the detection device is arranged is a direction reverse to the reference direction, the determination device determines that the detection device is arranged in a tire on a vehicle inner side, of the double tires. While the double tires are attached on a left side of the vehicle, when the direction of revolution of the tire where the detection device is arranged is the reference direction, the determination device determines that the detection device is arranged in a tire on the vehicle inner side, of the double tires, and when the direction of revolution of the tire where the detection device is arranged is the direction reverse to the reference direction, the determination device determines that the detection device is arranged in a tire on the vehicle outer side, of the double tires.

According to the aspect above, in which of the double tires the detection device is arranged can be determined.

Though an embodiment of the present invention has been described, it should be understood that the embodiment disclosed herein is illustrative and non-restrictive in every respect. The scope of the present invention is defined by the terms of the claims and is intended to include any modifications within the scope and meaning equivalent to the terms of the claims.

What is claimed is:

1. A tire revolution direction determination system that determines a direction of revolution of a tire attached to a vehicle, the tire revolution direction determination system comprising:
a detection device arranged in the tire; and
a determination device configured to obtain information from the detection device, wherein
the detection device includes
a first sensor arranged in the tire, the first sensor detecting a first acceleration in a tire diameter direction, and
a second sensor arranged in the tire, the second sensor detecting a second acceleration in the tire diameter direction,
the tire includes a wheel portion including a first-side surface and a second-side surface on a rear side of the first-side surface,
with a direction of clockwise revolution when the tire is viewed from the second-side surface being defined as a reference direction, the first sensor is arranged in front of the second sensor in the reference direction,
when the determination device receives the first acceleration and the second acceleration from the detection device while the vehicle travels forward, the determination device specifies change over time of the first acceleration and change over time of the second acceleration, and
the determination device determines whether the direction of revolution of the tire where the detection device is arranged is the reference direction based on whether change over time of the first acceleration is more advanced than change over time of the second acceleration.

2. The tire revolution direction determination system according to claim 1, wherein
the first sensor is arranged at a position distant by a prescribed angle of revolution in the reference direction from the second sensor, and
the prescribed angle of revolution is set to a value smaller than 180°.

3. The tire revolution direction determination system according to claim 1, wherein
the detection device is configured to transmit to the determination device, a result of detection of the first acceleration and the second acceleration at a plurality of consecutive timings.

4. The tire revolution direction determination system according to claim 1, wherein
when change over time of the first acceleration received from the detection device is more advanced than change over time of the second acceleration, the determination device determines the direction of revolution of the tire where the detection device is arranged as the reference direction, and
when change over time of the first acceleration received from the detection device is lagged behind change over time of the second acceleration, the determination device determines the direction of revolution of the tire where the detection device is arranged as a direction reverse to the reference direction.

5. The tire revolution direction determination system according to claim 1, wherein
the determination device is arranged in the tire.

6. The tire revolution direction determination system according to claim 1, wherein
the detection device is arranged in each of two tires attached back-to-back to the vehicle, and
the determination device determines in which of the two tires the detection device is arranged based on a result of determination of the direction of revolution of the tire where the detection device is arranged.

7. The tire revolution direction determination system according to claim 6, wherein
the two tires are double tires coupled in such a manner that the first-side surfaces of the two tires face each other,
while the double tires are attached on a right side of the vehicle,
when the direction of revolution of the tire where the detection device is arranged is the reference direction, the determination device determines that the detection device is arranged in a tire on a vehicle outer side, of the double tires, and
when the direction of revolution of the tire where the detection device is arranged is a direction reverse to the reference direction, the determination device determines that the detection device is arranged in a tire on a vehicle inner side, of the double tires, and
while the double tires are attached on a left side of the vehicle,
when the direction of revolution of the tire where the detection device is arranged is the reference direction, the determination device determines that the detection device is arranged in the tire on the vehicle inner side, of the double tires, and
when the direction of revolution of the tire where the detection device is arranged is the direction reverse to the reference direction, the determination device determines that the detection device is arranged in a tire on the vehicle outer side, of the double tires.
